(19) United States
(12) Patent Application Publication
(10) Pub. No.: US 2002/0011207 A1
(43) Pub. Date: Jan. 31, 2002

(54) Exposure apparatus, coating/developing system, device manufacturing system, device manufacturing method, semiconductor manufacturing factory, and exposure apparatus maintenance method

(76) Inventors: Shigeyuki Uzawa, Tokyo (JP); Izumi Tsukamoto, Tokyo (JP)

Correspondence Address: FITZPATRICK CELLA HARPER & SCINTO, 30 ROCKEFELLER PLAZA, NEW YORK, NY, 10112, US

(21) Appl. No.: 09/864,309

(22) Filed: May 25, 2001

(30) Foreign Application Priority Data
May 31, 2000 (JP) 163844/2000
May 1, 2001 (JP) 134473/2001

(51) Int. Cl. B05C 11/00

(52) U.S. Cl. 118/666

(57) ABSTRACT

The interior of a port mechanism for exchanging a wafer between a coating/developing system and an exposure apparatus is evacuated, and a predetermined atmospheric gas is introduced. In loading/unloading a wafer into/from the exposure apparatus, the wafer is heated/cooled as needed.

### FIELD OF THE INVENTION

The present invention relates to an exposure apparatus, coating/developing system, device manufacturing system, device manufacturing method, semiconductor manufacturing factory, and exposure apparatus maintenance method that are used to manufacture a semiconductor element and the like.

### BACKGROUND OF THE INVENTION

Exposure light of an exposure apparatus is decreasing in wavelength in order to increase the resolution of a projection optical system and expose a wafer to a finer pattern. For example, in exposure with a short wavelength of KrF or the like as represented by a fluorine excimer laser, a coater/developer (Coating/Developing System: CDS) for coating a wafer to be exposed with a resist and developing the exposed wafer is generally connected in line to an exposure apparatus. This is because a resist poor in chemical resistance is used and degraded by ammonia or the like, influencing the quality of an exposed image. In-line connection is therefore adopted to shorten the time after coating and keep the wafer in a predetermined controlled environment.

FIG. 16 schematically shows a conventional semiconductor manufacturing system adopting in-line connection.

In FIG. 16, reference numeral 51 denotes a CDS (coating/developing system) having a coater for coating a wafer with a resist and a developer for developing the exposed wafer; 52, an exposure apparatus; 53, an interface for transporting the wafer between the CDS 51 and the exposure apparatus 52; 54, a wafer hand for transferring the wafer to a predetermined position; 55, a pre-alignment unit for detecting a reference mark position on the wafer before exposure; 56, a wafer stage which supports the wafer and is driven in the X, Y, Z, θ, and tilt directions; and 57, a manual loading/unloading port section. The pre-alignment unit 55 pre-aligns a wafer at a predetermined temperature in order to prevent measurement errors caused by expansion/contraction of the wafer.

An actual wafer flow will be explained with reference to the flow chart of FIG. 17.

If a wafer subjected to circuit pattern formation is loaded into the CDS 51 (step 101), the wafer is coated with a resist by a resist coating unit 51a of the CDS 51 (step 102). The wafer is temporarily heated to a high temperature (pre-baked) by a heating unit 51b (step 103), and cooled by a cooling unit 51c (step 104). The wafer passes through the interface 53 (step 105), and is transported to the exposure apparatus 52 (step 106). The wafer loaded into the exposure apparatus 52 is pre-aligned by the pre-alignment unit 55 (step 107), and set on the wafer stage 56. The wafer is aligned with the reticle by the wafer stage 56 of the exposure apparatus 52 (step 108), and is exposed to a predetermined integrated circuit image (step 109). The exposed wafer is returned to the CDS 51 via the interface 53. The wafer is heated to a high temperature (post exposure bake; to be referred to as PEB hereinafter) by a heating/cooling unit 51d of the CDS 51 (step 110), cooled (step 111), and then developed by a developing unit 51e (step 112). The time till developing processing after exposure also greatly influences chemical changes of the resist. After developing processing, the wafer is unloaded from the CDS 51 via a heating unit 51f and cooling unit 51g (step 113), and transported to other processing apparatuses.

In the above process, the wafer is always kept in a predetermined clean environment. Particularly when the wafer is set in the same environment as that of the developer or coater in the CDS, the cleanliness decreases. To set a wafer in a very clean environment, the cost inevitably rises.

Further, the recent trend of low chemical resistance of a resist leads a stricter cleanliness standard.

### SUMMARY OF THE INVENTION

It is the first object of the present invention to overcome the conventional drawbacks and directly load/unload a wafer into/from a CDS without decreasing the internal cleanliness of an exposure apparatus.

It is the second object of the present invention to reduce degradation of the image quality caused by resist degradation.

To achieve the above objects, according to the present invention, an exposure apparatus for exposing a wafer to a pattern of a master is characterized by comprising a chamber that surrounds a predetermined space in the exposure apparatus, an air-conditioner for adjusting an internal atmosphere of the exposure apparatus, and a port section having a load-lock mechanism.

The port section generally comprises an exhaust mechanism for exhausting gas from the port section and a supply mechanism for supplying gas into the port section, and desirably comprises a door for shielding the port section from outside of the exposure apparatus and a door for shielding the port section from the chamber.

The port section preferably includes a plurality of port sections, and may include, e.g., a first port section for loading the wafer and a second port section for unloading the wafer.

The exposure apparatus generally further comprises an interface for stocking a wafer between the port section and outside of the exposure apparatus, and preferably between the port section and a coating/developing system. The interface desirably comprises a load-lock mechanism, and may be shared between a first port section for loading a wafer and a second port section for unloading the wafer.

In the present invention, the port section desirably comprises a temperature control mechanism for controlling a temperature of the wafer. The temperature control mechanism desirably comprises a heater for heating the wafer and/or a cooler for cooling the wafer. The heater heats a wafer and/or exposed wafer. The cooler cools a heated wafer. The temperature control mechanism can perform temperature control such as heating of the wafer while an internal atmosphere of the port section is set close to an internal atmosphere of the exposure apparatus. For example, the wafer is desirably heated while gas in the port section is exhausted, and cooled while gas is supplied to the port section.

The exposure apparatus may further comprise a temperature controller incorporated in the chamber to control a temperature of the wafer. In this case, the exposure apparatus further comprises another air-conditioner which is different from the air-conditioner and adjusts an ambient atmosphere of the temperature controller.

According to the present invention, a wafer transfer method of transferring a wafer into the exposure apparatus of the present invention is characterized by comprising the steps of transferring a wafer coated with a resist or anti-reflective agent to a port section having a load-lock mechanism, heating the wafer transferred to the port section, exhausting gas from the port section, cooling the heated wafer, supplying gas to the port section, and transferring the wafer in the port section to the exposure apparatus. The wafer transfer method preferably further comprises the step of controlling a temperature of the wafer transferred to the exposure apparatus by an internal temperature controller of the exposure apparatus.

According to the present invention, a wafer processing method is characterized by comprising the steps of coating a wafer with a resist or anti-reflective agent, heating the wafer, and exhausting an ambient atmosphere of the wafer before heating of the wafer ends. The wafer processing method preferably further comprises the step of supplying gas around the wafer after an ambient atmosphere of the wafer is exhausted. More preferably, the wafer processing method further comprises the step of cooling the heated wafer before the step of supplying gas around the wafer ends.

According to the present invention, a coating/developing system having a resist coating unit for coating a wafer with a resist and a developing unit for developing the exposed wafer is characterized by comprising a door for shielding the coating/developing system from a heating unit disposed outside the coating/developing system in order to pre-bake the wafer.

In general, the coating/developing system further comprises a hand for unloading the wafer to the heating unit, and a controller for controlling the hand. The controller can select a plurality of external heating units and control transfer of the wafer. The coating/developing system may further comprise another hand which is different from the hand and loads the wafer from a device outside the coating/developing system. The hand for loading the wafer can be used as a hand for loading a heated wafer from an external device for heating an exposed wafer.

A device manufacturing system according to the present invention having the exposure apparatus of the present invention and/or the coating/developing system of the present invention is characterized by comprising a coating/developing system having a resist coating unit for coating a wafer with a resist and a developing unit for developing the exposed wafer, an exposure apparatus for exposing the wafer to a pattern of a master, a port section which is interposed between the coating/developing system and the exposure apparatus and has a load-lock mechanism, and a temperature control mechanism incorporated in the port section to control a temperature of the wafer.

The above arrangement can efficiently load/unload a wafer with a small amount of purge gas without decreasing the internal cleanliness of the chamber when the interior of the chamber is kept in a predetermined atmosphere, e.g., an inert gas atmosphere of nitrogen or helium.

Resist degradation can be prevented because the time taken from heating to exposure can be shortened in loading a wafer into the exposure apparatus. Resist degradation can be prevented because heating can be done in an exposure atmosphere separated from the atmosphere of the resist coating unit in unloading the wafer. As a result, degradation of the image quality caused by resist degradation can be prevented. When the temperature controller is arranged in the chamber, the ambient atmosphere of the temperature controller is desirably adjusted by another air-conditioner different from the air-conditioner for adjusting the internal environment of the chamber. For this purpose, part of the purge environment of the exposure apparatus is set as a wafer heating/cooling place. A temperature adjustment/purge system different from that of the exposure apparatus is arranged at this place, return gas from this place is exhausted, or another circulation system is arranged.

When the temperature control mechanism is arranged in the port section, the atmosphere in the port section can be purged at the same time as wafer heating (pre-bake and PEB) and subsequent cooling. The standby time can be effectively used, and the time taken from resist coating to exposure or from exposure to developing can be shortened. Resultantly, the total throughput can be increased, and degradation of the image quality caused by resist degradation can be reduced.

Particularly in the first port section for loading a wafer, the substance around the wafer can be exhausted in heating by controlling to set a vacuum (low-pressure) atmosphere during wafer heating and purging the atmosphere by inert gas in cleaning. The impurity concentration in the chamber mechanism can be reduced, achieving high purge performance.

The present invention need not adopt separate port sections for loading and unloading a wafer, and can achieve the above objects by one port section used for both loading and unloading. However, two or more port sections are generally arranged to load and unload a plurality of wafers parallel to each other. When two port sections are separately arranged for loading and unloading, the wafer loading port section may comprise only a wafer heater.

If the exposure apparatus of the present invention is equipped with a display, network interface, and computer for executing network software, maintenance information of the exposure apparatus can be communicated via the computer network. The network software is connected to an external network of a factory where the exposure apparatus is installed, provides on the display a user interface for accessing a maintenance database provided by a vendor or user of the exposure apparatus, and enables obtaining information from the database via the external network.

According to the present invention, a device manufacturing method is characterized by comprising the steps of installing manufacturing apparatuses for various processes including the exposure apparatus and CDS in a semiconductor manufacturing factory, and manufacturing a semiconductor device by using the manufacturing apparatuses in a plurality of processes. The device manufacturing method may further comprise the steps of connecting the manufacturing apparatuses by a local area network, and communicating information about at least one of the manufacturing apparatuses between the local area network and an external network outside the semiconductor manufacturing factory. In addition, a database provided by a vendor or user of the exposure apparatus may be accessed via the external network to obtain maintenance information of the manufacturing apparatus by data communication, or production management may be performed by data communication between the semiconductor manufacturing factory and another semiconductor manufacturing factory via the external network.

A semiconductor manufacturing factory according to the present invention comprises manufacturing apparatuses for various processes including the exposure apparatus and CDS of the present invention, a local area network for connecting the manufacturing apparatuses, and a gateway which allows the local area network to access an external network outside the factory, wherein information about at least one of the manufacturing apparatuses can be communicated.

According to the present invention, a maintenance method for an exposure apparatus is characterized by comprising the steps of causing a vendor or user of the exposure apparatus to provide a maintenance database connected to an external network of the semiconductor manufacturing factory, authorizing access from the semiconductor manufacturing factory to the maintenance database via the external network, and transmitting maintenance information accumulated in the maintenance database to the semiconductor manufacturing factory via the external network.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic sectional view showing an example of a semiconductor exposure apparatus using an F₂ excimer laser as a light source according to the present invention;

FIG. 2 is a schematic view showing a semiconductor manufacturing system according to the second embodiment of the present invention;

FIG. 3 is a flow chart showing a processing flow in the semiconductor manufacturing system of FIG. 2;

FIG. 4 is a schematic view showing a semiconductor manufacturing system according to the second embodiment of the present invention;

FIG. 5 is a schematic sectional view showing an in-line port section in FIG. 4 taken along the line A-A′;

FIG. 6 is a schematic view showing a semiconductor manufacturing system according to the third embodiment of the present invention;

FIG. 7 is a flow chart showing a processing flow in the semiconductor manufacturing system of the third embodiment shown in FIG. 6;

FIG. 8 is a schematic view showing a semiconductor manufacturing system according to an improvement of the second embodiment of the present invention;

FIG. 9 is a flow chart showing a processing flow in the semiconductor manufacturing system of FIG. 8;

FIG. 10 is a schematic view showing a semiconductor manufacturing system according to another improvement of the second embodiment of the present invention;

FIG. 11 is a schematic view showing a semiconductor manufacturing system according to still another improvement of the second embodiment of the present invention;

FIG. 12 is a schematic view showing a semiconductor manufacturing system according to still another improvement of the second embodiment of the present invention;

FIG. 13 is a schematic view showing a semiconductor manufacturing system according to the fourth embodiment of the present invention;

FIG. 14 is a flow chart showing a processing flow in the semiconductor manufacturing system of the fourth embodiment shown in FIG. 13;

FIG. 15 is a schematic sectional view showing another example of a semiconductor exposure apparatus using an F₂ excimer laser as a light source according to the present invention;

FIG. 16 is a schematic view showing a conventional semiconductor manufacturing system adopting in-line connection;

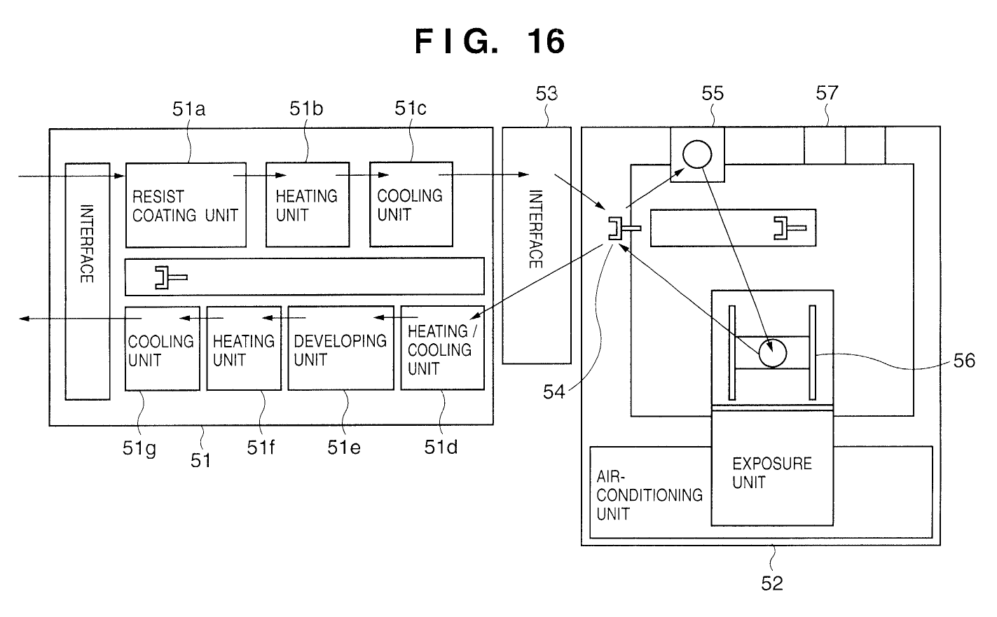

FIG. 17 is a flow chart showing a processing flow in the semiconductor manufacturing system of FIG. 16;

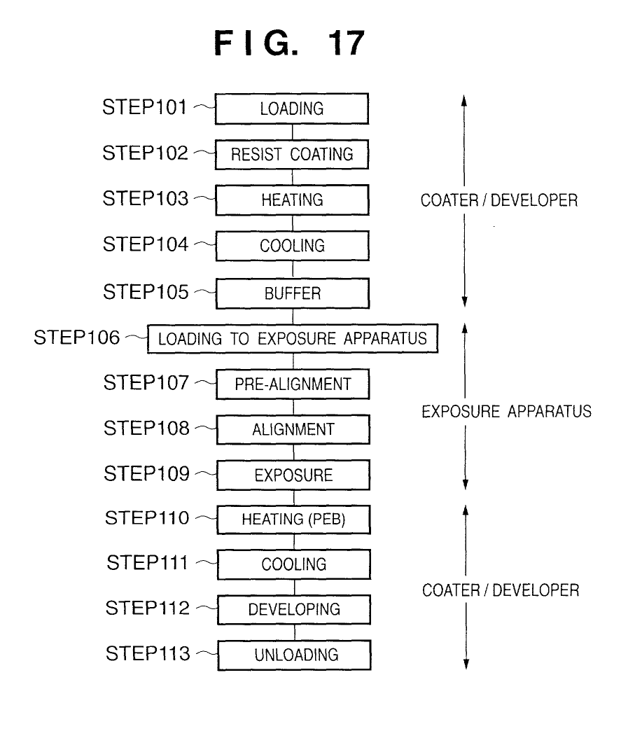

FIG. 18 is a view showing the concept of a semiconductor device production system when viewed from a given angle;

FIG. 19 is a view showing the concept of the semiconductor device production system when viewed from another given angle;

FIG. 20 is a view showing an example of a user interface;

FIG. 21 is a flow chart for explaining the flow of a device manufacturing process; and

FIG. 22 is a flow chart for explaining a wafer process.

### DETAILED DESCRIPTION OF THE PREFERRED EMBODIMENTS

Preferred embodiments of the present invention will be described below.

[First Embodiment]

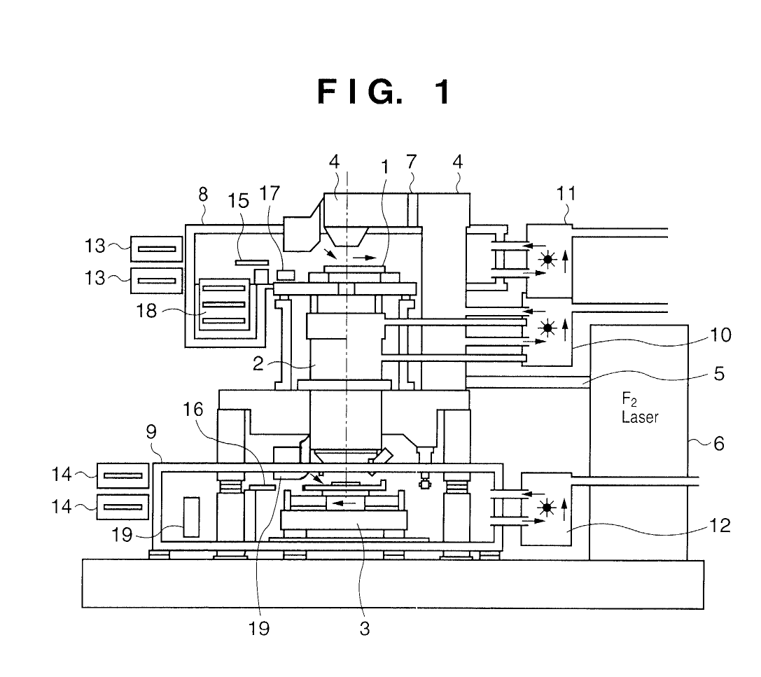

FIG. 1 is a schematic sectional view showing an example of a semiconductor exposure apparatus using an F₂ excimer laser as a light source according to the present invention.

In FIG. 1, reference numeral 1 denotes a reticle stage for setting a reticle bearing a pattern; 2, a projection optical system for projecting the pattern on the reticle onto a wafer; 3, a wafer stage which supports the wafer and is driven in the X, Y, Z, θ, and tilt directions; 4, an illumination optical system for illuminating the reticle with illumination light; 5, a guide optical system for guiding light from the light source to the illumination optical system 4; 6, an F₂ laser serving as a light source; 7, a masking blade for shielding exposure light so as not to illuminate the reticle except for the pattern region; 8 and 9, housings which cover the exposure light path around the reticle stage 1 and wafer stage 3, respectively; 10, an He air-conditioner for adjusting the interiors of the projection optical system 2 and illumination optical system 4 to a predetermined He atmosphere; 11 and 12, N₂ air-conditioners for adjusting the interiors of the housings 8 and 9 to a predetermined N₂ atmosphere; 13 and 14, reticle load-lock chambers and wafer load-lock chambers used to load the reticle and wafer into the housings 8 and 9, respectively; 15 and 16, a reticle hand and wafer hand for transferring the reticle and wafer, respectively; 17, a reticle alignment mark used to adjust the reticle position; 18, a reticle stocker for stocking a plurality of reticles in the housing 8; and 19, a pre-alignment unit for pre-aligning the wafer.

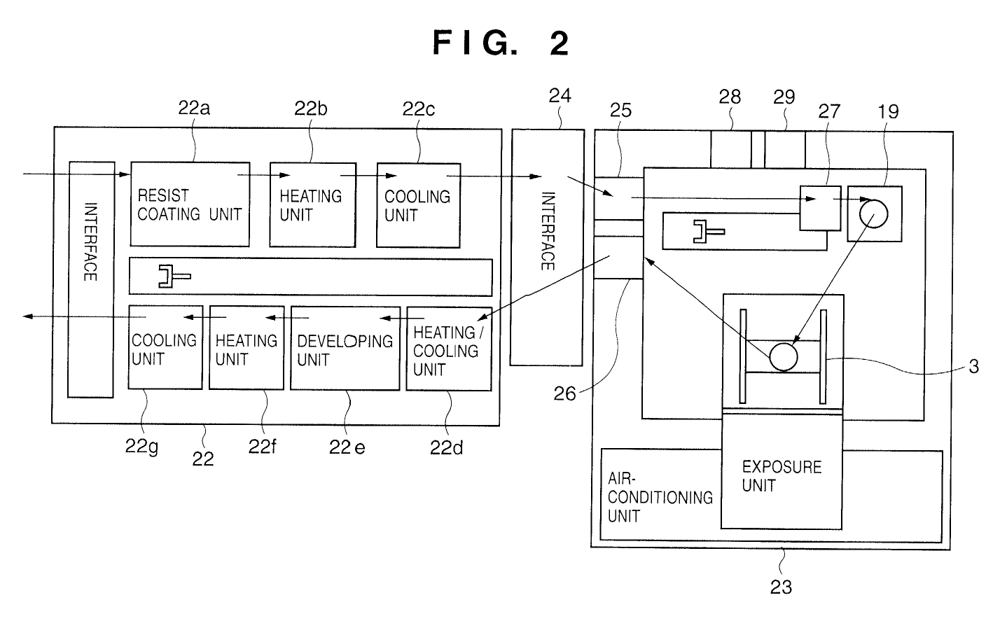

FIG. 2 is a schematic view showing an example of a semiconductor manufacturing system including the exposure apparatus shown in FIG. 1 and a coating/developing system.

In FIG. 2, reference numeral 22 denotes a CDS (Coating/Developing System) having a coater for coating a wafer with a resist and a developer for developing the exposed wafer; 23, an exposure apparatus; 24, an interface for transporting the wafer between the CDS 22 and the exposure apparatus 23; 25 and 26, in-line port sections (25, a first port section; and 27, a second port section); and 28 and 29, manual loading/unloading port sections. Each port section has a load-lock mechanism.

The load-lock mechanism has a mechanism of shielding the internal space of the port section from the outside and setting the internal atmosphere of the port section to be almost the same as that of the exposure apparatus in, e.g., loading/unloading a wafer into/from the exposure apparatus. In this case, a door is closed to shield the internal space of the port section from the external space, the internal atmosphere of the port section shielded from the outside is set almost the same as that of the exposure apparatus, a door between the port section and the exposure apparatus is opened, and then a wafer is transferred.

The port section comprises as the load-lock mechanism of the port section a shielding mechanism (e.g., door) for shielding the internal space of the port section from the outside, an exhaust mechanism (e.g., pump) for exhausting the internal gas of the port section, and a supply mechanism for supplying the same gas as the internal atmosphere of the exposure apparatus to the port section. Thus, the in-line port sections 25 and 26 comprise doors disposed on the interface 24 side, doors disposed on the exposure apparatus 23 side, exhaust pumps for exhausting the internal gas of the in-line port sections 25 and 26, and N₂ gas supply mechanisms for supplying the same gas as the internal atmosphere of the exposure apparatus 23 into the in-line port sections 25 and 26. The manual loading/unloading port sections 28 and 29 comprise outer doors, doors disposed on the exposure apparatus side, exhaust pumps for exhausting the internal gas of the manual loading/unloading port sections 28 and 29, and N₂ gas supply mechanisms for supplying the same gas as the internal atmosphere of the exposure apparatus 23 into the manual loading/unloading port sections 28 and 29.

The pre-alignment unit 19 pre-aligns a wafer at a predetermined temperature in order to prevent measurement errors caused by expansion/contraction of the wafer.

The interface 24 has the same mechanism as the load-lock mechanism. In this case, the interface 24 comprises a door disposed on the CDS 22 side, doors disposed on the sides of the in-line port sections 25 and 26, an exhaust pump for exhausting the internal gas of the interface 24, and a supply mechanism for supplying an atmospheric gas into the interface in order to set the internal atmosphere of the interface to be the same as that of the port sections 25 and 26. In transferring a wafer to the in-line port sections 25 and 26, the internal atmosphere of the interface 24 is set almost the same as that of the in-line port sections 25 and 26.

When the interface 24 has a load-lock mechanism, the internal atmosphere of the interface 24 need not be strictly purged, unlike that of the exposure apparatus 23, and the load-lock mechanism suffices to set the internal atmosphere of the interface 24 to be close to that of the in-line port sections 25 and 26.

The load-lock mechanism of the interface 24 can reduce contamination of the exposure apparatus 23 and the in-line port sections 25 and 26 caused by the atmosphere of the CDS 22. The load-lock mechanism of the interface 24 may be shared between the in-line port section 25 for loading a wafer into the exposure apparatus 23 and the in-line port section 26 for unloading the wafer from the exposure apparatus 23.

The interface 24 may stock a plurality of wafers at once.

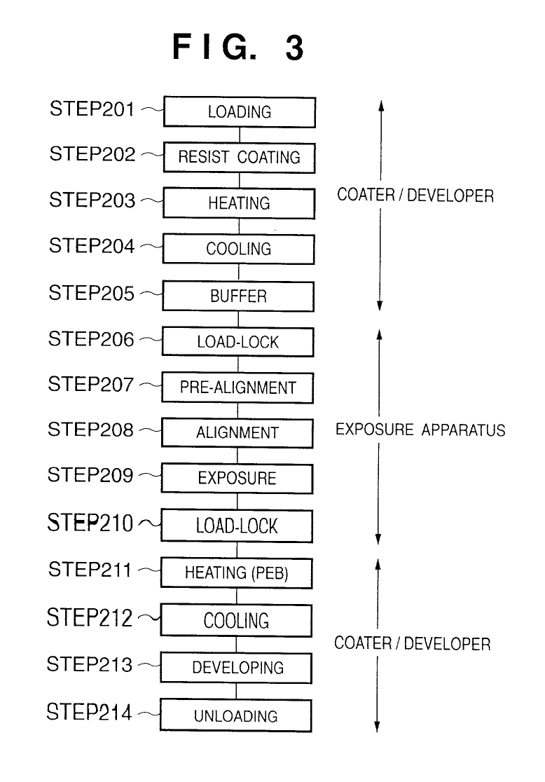

A processing flow in the semiconductor manufacturing system of the first embodiment shown in FIGS. 1 and 2 in the wafer process of the semiconductor manufacture will be explained with reference to the flow chart of FIG. 3. The operation of each apparatus in the first embodiment is controlled by a controller (not shown), and the controller controls the operation timing in the following flow chart.

If a wafer to be exposed to a circuit pattern is loaded into the CDS 22 (step 201), the wafer is coated with a resist by a resist coating unit 22a of the CDS 22 (step 202). The wafer is heated and pre-baked by a heating unit 22b (100° C., about 1 min) (step 203). The heated wafer is cooled by a cooling unit 22c (step 204).

The cooled wafer is transported to the exposure apparatus 23 via the interface 24 (step 205). The interface 24 is shielded from outside air so as to allow the internal spaces of the CDS 22 and exposure apparatus 23 to communicate with each other. While being shielded from outside air via the interface 24, the wafer is loaded into the in-line port section 25 having the load-lock function. The in-line port sections 25 and 26 have doors on the CDS 22 side (interface 24 side) and exposure apparatus 23 side, respectively. When the wafer is loaded from the interface 24, the door on the exposure apparatus 23 side is kept closed. After the wafer is loaded, the door on the CDS 22 side is also closed to ensure a sealed state. The internal pressure of the in-line port section 25 is reduced by the exhaust pump. The N₂ gas supply mechanism supplies N₂ gas to the in-line port section 25 to obtain the same N₂ atmosphere as the interior of the exposure apparatus 23 (step 206).

If the interior of the in-line port section 25 reaches a predetermined atmosphere, the door of the in-line port section 25 on the exposure apparatus 23 side is opened, and the wafer is transported by a transfer hand to a wafer temperature adjustment unit 27 where the wafer is adjusted to a predetermined temperature. Then, the wafer is pre-aligned by the pre-alignment unit 19 (step 207). The wafer is set on the wafer stage 3, aligned with a reticle (step 208), and exposed to an integrated circuit image (step 209).

The exposed wafer is loaded into the in-line port section 26 so as to return to the CDS 22 (step 210). The wafer unloading in-line port section 26 obtains the N₂ atmosphere by the load-lock function in advance by the end of exposure processing in step 209, and is adjusted not to degrade the atmosphere in the internal space of the exposure apparatus 23 even if the door on the exposure apparatus 23 side is opened. The door of the in-line port section 26 on the CDS 22 side is kept closed, and after the wafer is loaded into the in-line port section 26, the door on the exposure apparatus 23 is closed. Then, the door on the interface 24 side is opened, and the wafer is transported to the CDS 22 via the interface 24.

The wafer is transferred to a heating/cooling unit 22d of the CDS 22, heated again for PEB (step 211), and cooled (step 212). The wafer is transferred to a developing unit 22e where it is developed (step 213). After that, the wafer is unloaded from the CDS 22 via a heating unit 22f and cooling unit 22g (step 214), and transported to other processing apparatuses.

As described above, the first embodiment can prevent degradation of the internal atmosphere of the exposure apparatus in loading/unloading the wafer into the exposure apparatus.

[Second Embodiment]

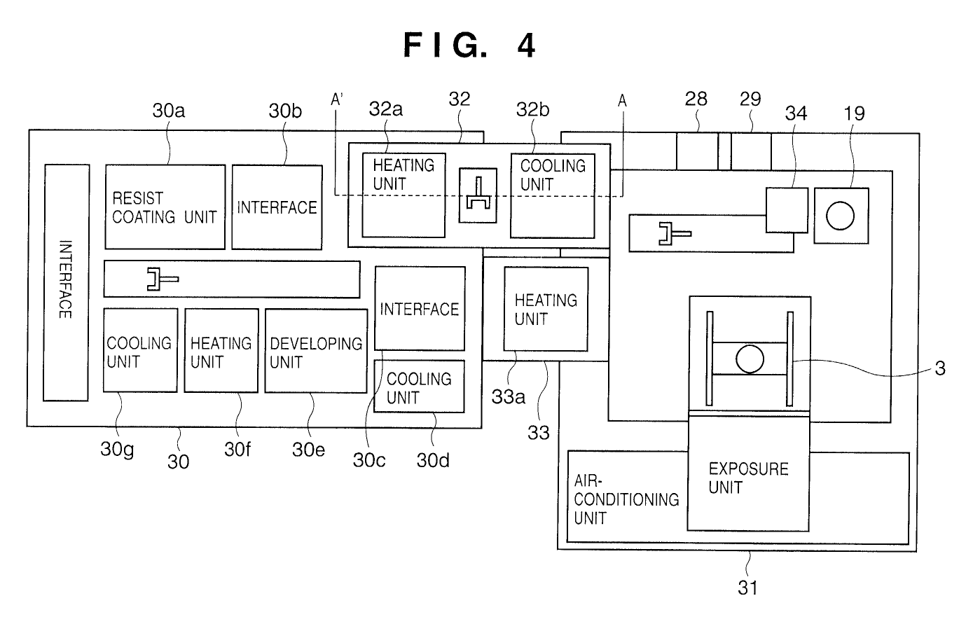

FIG. 4 is a schematic sectional view showing an example of a semiconductor exposure apparatus according to the second embodiment of the present invention.

In the second embodiment, a first in-line port section 32 for transporting a wafer from a CDS 30 to an exposure apparatus 31 comprises a heating unit (heater) 32a and cooling unit (cooler) 32b serving as a wafer temperature control mechanism. A second in-line port section 33 for transporting the wafer from the exposure apparatus 31 to the CDS 30 comprises a wafer heating unit 33a. The CDS 30 comprises a resist coating unit 30a, interfaces 30b and 30c, a cooling unit 30d after PEB, a developing unit 30e, and a heating unit 30f and cooling unit 30g after developing processing.

The pre-bake heating and cooling units and the PEB heating unit are disposed in the in-line port sections 32 and 33, and need not be disposed in the CDS 30. Reference numeral 34 denotes a wafer temperature adjustment unit which has only a function of slightly adjusting the wafer temperature because the temperature is substantially adjusted by the cooling unit 32b in the second embodiment.

In the second embodiment, the heating unit 33a for performing PEB desirably has a humidity adjustment function in order to control the environment atmosphere in PEB and not to degrade the atmosphere in the housing of the exposure apparatus 31 in loading a wafer because the resist resolution may be adversely affected by PEB performed in a completely dry environment.

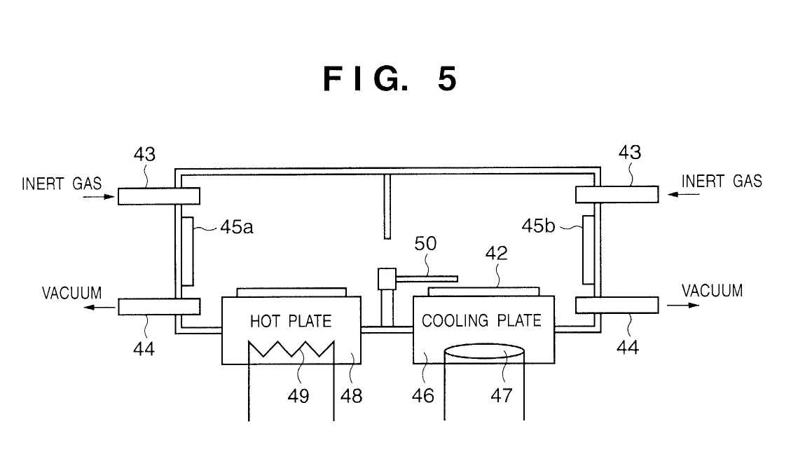

The internal structure of the in-line port section 32 in the second embodiment will be explained in detail with reference to FIG. 5.

FIG. 5 is a schematic sectional view showing the in-line port section 32 in FIG. 4 taken along the line A-A′. In FIG. 5, reference numeral 42 denotes a wafer to be transferred; 43, a supply pipe for supplying N₂ gas as inert gas to the in-line port section 32; 44, an exhaust pipe for evacuating the interior of the in-line port section or reducing its internal pressure; 45a, a door attached to the in-line port section 32 on the CDS 30 side; and 45b, a door attached to the in-line port section 32 on the exposure apparatus 31 side. When these doors are closed, the in-line port section is sealed. Reference numeral 46 denotes a cooling plate for cooling the wafer 42; 47, a Peltier element; 48, a hot plate for heating the wafer 42; 49, a heater; and 50, a wafer hand for transferring the wafer 42 within the in-line port section 32.

In the semiconductor manufacturing system of the second embodiment, the door 45b of the in-line port section 32 on the exposure apparatus 31 side is kept closed when the wafer 42 coated with a resist by the resist coating unit 30a is loaded from the interface 30b to the exposure apparatus 31. After the wafer 42 is set on the hot plate 48, the door 45a of the in-line port section 32 on the CDS 30 side is also closed. A vacuum atmosphere is prepared by reducing the internal pressure by suction of an exhaust pump via the exhaust pipe 44. While the internal pressure of the in-line port section 32 is reduced, the heater 49 heats the hot plate 48 to pre-bake the wafer 42. After the wafer 42 is pre-baked, the wafer hand 50 moves the wafer 42 onto the cooling plate 46. The Peltier element 47 cools the wafer 42 on the cooling plate 46. When the internal atmosphere of the in-line port section 32 reaches a desired vacuum atmosphere, N₂ gas is supplied via the supply pipe 43 to set the internal atmosphere of the in-line port section 32 to be the same N₂ atmosphere as that of the exposure apparatus 31. After the wafer 42 is cooled, and the interior of the in-line port section 32 reaches a predetermined N₂ atmosphere, the door 45b of the in-line port section on the exposure apparatus 31 side is opened, and the wafer 42 is transported to the wafer temperature adjustment unit 34 by the wafer hand 50 of the exposure apparatus 31.

The wafer 42 transported to the wafer temperature adjustment unit 34 is slightly adjusted in temperature, and pre-aligned by the pre-alignment unit 19. Upon the completion of alignment and exposure of the wafer 42, the wafer 42 is transferred to the second in-line port section 33 and subjected to PEB by the heating unit 33a.

Almost similar to the first in-line port section 32, the second in-line port section 33 comprises a door (not shown) disposed on the exposure apparatus side and a door disposed on the CDS 30 side in order to seal itself.

In the second in-line port section 33, pressure reduction and purge in the port section must be completed before the wafer 42 is loaded. Thus, after the wafer 42 is loaded from the exposure apparatus 31 to the second in-line port section 33, a standby time as long as the time taken in the first in-line port section 32 is not required until the wafer 42 is transferred to the interface 30c. Hence, the second in-line port section 33 is equipped with only the heating unit 33a without any cooling unit.

The arrangement of the present invention is not limited to the above one. For example, the interface 30b may comprise a load-lock mechanism as described in the first embodiment. The heating and cooling units of the first in-line port section 32 may be separated. In the second embodiment, the second in-line port section 33 is equipped with only the heating unit 33a but may also be equipped with the cooling unit 30d.

In the above description, while the heating unit 32a of the first in-line port section 32 heats a wafer, the internal atmosphere of the in-line port section 32 is exhausted, and while the cooling unit 32b cools the wafer, N₂ is supplied to set the interior of the in-line port section 32 to be close to the internal atmosphere of the exposure apparatus 31. However, the present invention is not limited to this. For example, if the wafer heating time or N₂ supply time is long, N₂ may be supplied to the in-line port section 32 after evacuation while a wafer is heated. Similarly, if the wafer cooling time or the evacuation time of the in-line port section 32 is long, the in-line port section 32 may be kept evacuated while the wafer is cooled. In either case, it is desirable to start exhausting the internal atmosphere of the in-line port section 32 at least before wafer heating ends, and to end wafer cooling at least before the door of the in-line port section on the exposure apparatus 31 side is opened (i.e., before gas supply to the in-line port section ends).

As described above, the second embodiment can prevent degradation of the internal atmosphere of the exposure apparatus without decreasing the throughput in loading/unloading a wafer into/from the exposure apparatus.

The second embodiment can reduce degradation of the image quality caused by resist degradation because the wafer atmosphere is controlled earlier than the prior art after a wafer is coated with a resist.

Further, the second embodiment can reduce degradation of the image quality caused by resist degradation because an exposed wafer undergoes PEB at an atmosphere-controlled place.

[Third Embodiment]

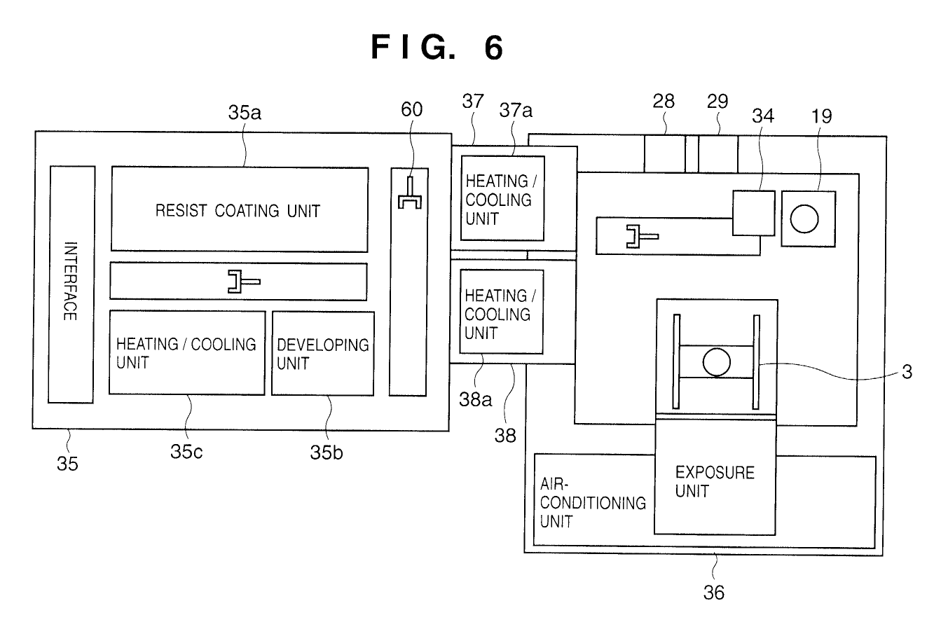

FIG. 6 is a schematic view showing an example of a semiconductor manufacturing system according to the third embodiment of the present invention.

In the third embodiment, wafer heating/cooling units 37a and 38a are installed in in-line port sections 37 and 38 for transferring a wafer from a CDS 35 to an exposure apparatus 36. The CDS 35 comprises a resist coating unit 35a, a developing unit 35b, and a heating/cooling unit 35c after developing processing, but does not require any pre-bake heating and cooling units or any PEB heating and cooling units. The CDS 35 has a transfer hand 60 for selecting either of the in-line port sections 37 and 38 and transferring a wafer coated with a resist by the resist coating unit 35a to the selected port section.

Reference numeral 34 denotes a wafer temperature adjustment unit which has only a function of slightly adjusting the temperature because the temperature is substantially adjusted by the wafer heating/cooling unit 37a in the third embodiment.

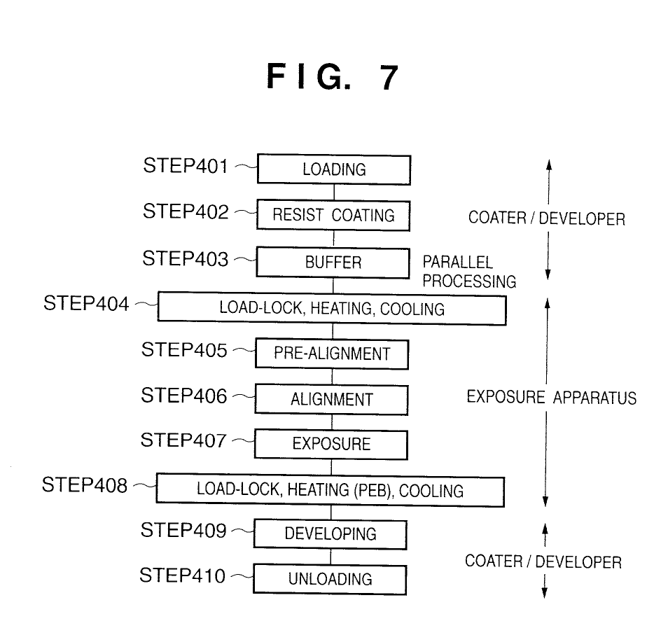

A processing flow in the semiconductor manufacturing system of the third embodiment shown in FIG. 6 in the wafer process of the semiconductor manufacture will be explained with reference to the flow chart of FIG. 7. The operation of each apparatus in the third embodiment is controlled by a controller (not shown), and the controller controls the operation timing in the following flow chart.

If a wafer to be exposed to a circuit pattern is loaded into the CDS 35 (step 401), the wafer is coated with a resist by the resist coating unit 35a of the CDS 35 (step 402). The wafer is loaded into the in-line port section 37 via a buffer (not shown) (step 403). In the in-line port section 37, the door on the exposure apparatus 36 side is kept closed. After the wafer is loaded from the door on the CDS 35 side and set on the wafer heating/cooling unit 37a, the two doors are closed to seal the in-line port section 37. Evacuation of the internal atmosphere, supply of N₂ gas, and pre-bake (100° C., about 1 min) and cooling of the wafer are performed parallel to each other (step 404). After parallel processing in step 404 ends, the door on the exposure apparatus 36 side is opened, and the wafer is transported by the transfer hand 60 of the exposure apparatus 36 to the wafer temperature adjustment unit 34 where the temperature of the wafer is slightly adjusted to a predetermined temperature. Then, the wafer is pre-aligned by a pre-alignment unit 19 (step 405).

The wafer is set on a wafer stage 3, aligned with a reticle (step 406), and exposed to an integrated circuit image (step 407). The exposed wafer is loaded into the in-line port section 37 again in order to return to the CDS 35 (step 408). The in-line port section 37 obtains the N₂ atmosphere in advance by parallel processing in step 404 so as not to degrade the atmosphere in the internal space of the exposure apparatus 36 even if the door on the exposure apparatus 36 side is opened. In loading the wafer again, the door of the in-line port section 37 on the CDS 35 side is kept closed, and the wafer is set on the wafer heating/cooling unit 37a of the in-line port section 37. The two doors are closed to seal the in-line port section 37, and then only the door on the CDS 35 side is opened. Meanwhile, the wafer undergoes PEB and cooling (step 408). The wafer is transported to the CDS 35 via the buffer, and transferred to the developing unit 35b of the CDS 35 where the wafer is developed (step 409). The wafer is unloaded from the CDS 35 via the heating/cooling unit 35c (step 410), and transported to other processing apparatuses.

The above-described wafer processing does not use the in-line port section 38 which incorporates the wafer heating/cooling unit 38a. This port section is used to successively process a plurality of wafers. That is, when a wafer is exposed, the port section 37 remains in the internal atmosphere of the exposure apparatus 36, and the next wafer cannot be loaded. If, however, the in-line port section 38 is used, a wafer can be loaded parallel, which enables successively processing a plurality of wafers without any standby time. Supply of a wafer to the in-line port section 37 or 38 and recovery of a wafer from the in-line port section 37 or 38 are performed by the transfer hand 60 on the basis of signals from the controller (not shown).

The third embodiment adopts two in-line port sections, but the present invention is not limited to this. For example, three or more in-line port section may be arranged.

The CDS 35 has one hand 60 in the third embodiment, but the present invention is not limited to this. For example, a plurality of hands for selectively transferring a wafer to a plurality of in-line port sections may be employed. Alternatively, a plurality of transfer hands 60 may be arranged for different purposes as an unloading hand for selectively unloading a wafer from the resist coating unit to a plurality of in-line port sections, and a loading hand for loading to the developing unit a wafer having undergone PEB in a selected in-line port section.

As described above, the third embodiment can prevent degradation of the internal atmosphere of the exposure apparatus without decreasing the throughput in loading/unloading a wafer into/from the exposure apparatus.

The third embodiment can reduce degradation of the image quality caused by resist degradation because the wafer atmosphere is controlled earlier than the prior art after a wafer is coated with a resist.

Moreover, the third embodiment can reduce degradation of the image quality caused by resist degradation because an exposed wafer undergoes PEB at an atmosphere-controlled place.

[First Improvement]

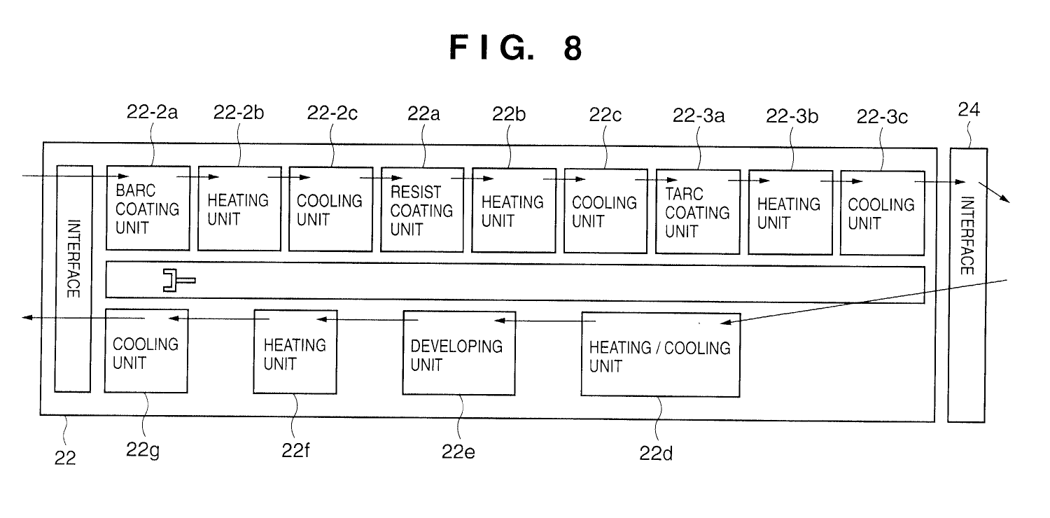

FIG. 8 is a schematic view showing an improvement of the embodiment in FIG. 2.

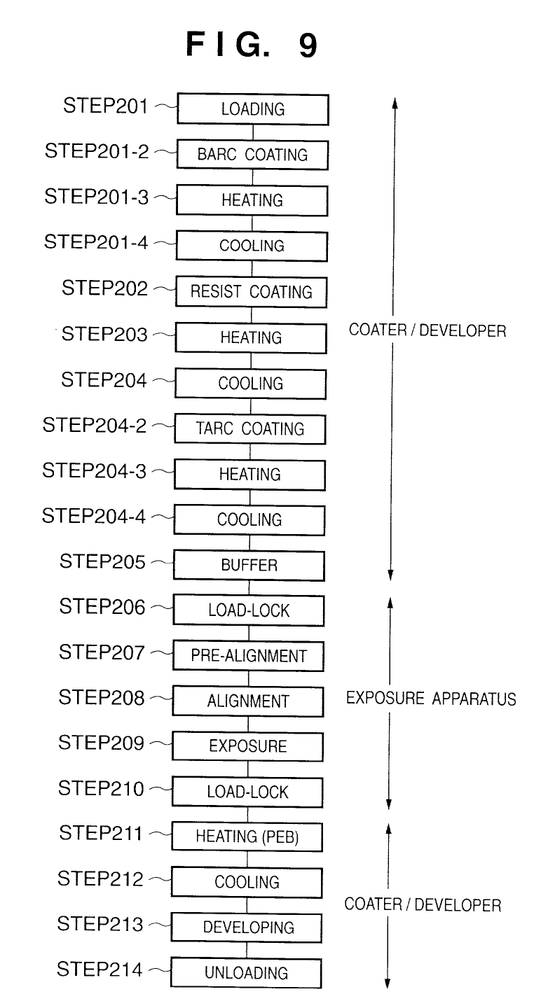

This improvement is different from the embodiment in FIG. 2 in that the improvement comprises coating, heating, and cooling units (22-2a to 22-2c) for the step (BARC: Bottom Anti-Reflective Coating) of forming an anti-reflective film on the lower layer of a resist layer on a substrate to be exposed, and coating, heating, and cooling units (22-3a to 22-3c) for the step (TARC: Top Anti-Reflective Coating) of forming an anti-reflective film on the upper layer of the resist layer. FIG. 9 is a flow chart showing a processing flow in the semiconductor manufacturing system of FIG. 8. This improvement is different from the embodiment in FIG. 3 in that the flow has the BARC coating, heating, and cooling steps (steps 201-2 to 201-4) and the TARC coating, heating, and cooling steps (steps 204-2 to 204-4).

In the above-described embodiment, only resist coating and the like are done in the CDS 22. In some cases, however, BARC and TARC are executed.

In BARC, an anti-reflective agent is spin-coated before resist coating, similar to a case wherein a wafer is coated with a resist. The wafer coated with the anti-reflective agent is heated/cooled as needed, and coated with a resist. BARC can prevent reflection of exposure light by a wafer substrate to improve the shape of a resist image.

In TARC, an anti-reflective agent is similarly spin-coated after resist coating. The wafer coated with the resist may be heated/cooled between resist coating and TARC. After TARC, the wafer coated with the anti-reflective agent is heated/cooled as needed. TARC can prevent reflection of exposure light to improve the shape of a resist image, and can increase the shielding property between the resist and the environment to prevent degradation of the resist image shape caused by an environmental factor.

[Second Improvement]

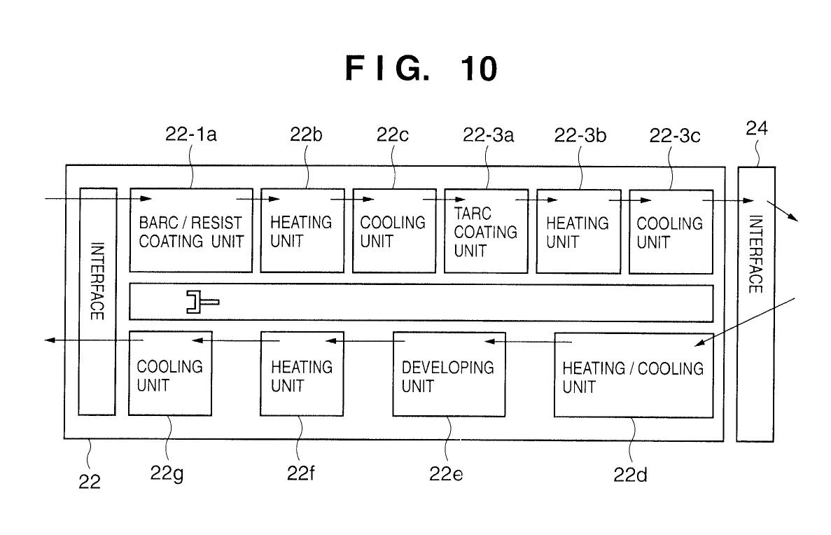

FIG. 10 is a schematic view showing an improvement when a BARC/resist coating unit 22a-1 is constituted by sharing the BARC coating unit 22-2a in FIG. 8 by the resist coating unit 22a. In this case, the BARC heating and coating units (22-2b and 22-2c) in the first improvement can also be shared.

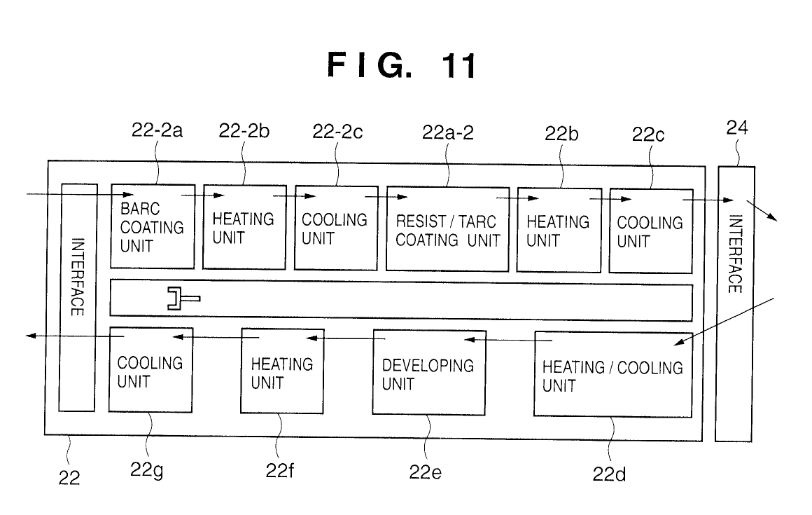

FIG. 11 is a schematic view showing an improvement when a resist/TARC coating unit 22a-2 is constituted by sharing the TARC coating unit 22-3a in FIG. 8 by the resist coating unit 22a. In this case, the TARC heating and coating units (22-3b and 22-3c) in the first improvement can also be shared.

In the second improvement, BARC or TARC coating or the like can be shared by resist coating or the like, resulting in a simple apparatus and high throughput.

Note that the BARC coating unit and resist coating unit, or the resist coating unit and TARC coating unit need not always be shared. Even in this case, the subsequent heating and cooling units can be shared.

[Third Improvement]

Heating and Cooling units after TARC need not always be performed.

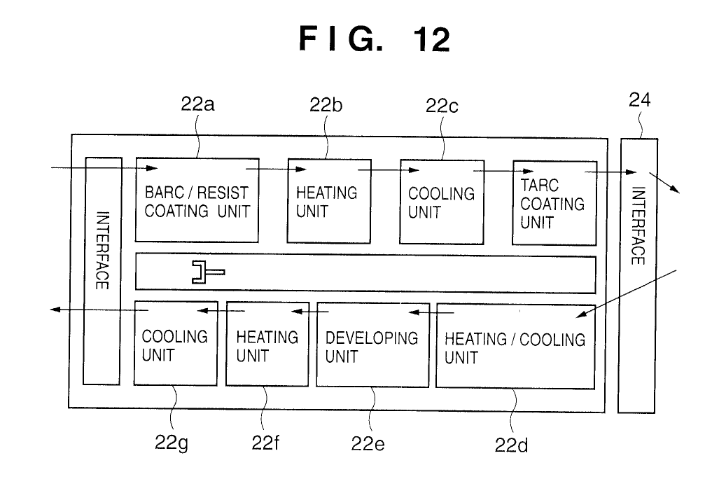

FIG. 12 is a schematic view when the heating or cooling step after TARC coating is omitted.

This improvement can omit heating/cooling after TARC coating, resulting in a simple arrangement and high throughput.

[Fourth Improvement]

In the embodiments of FIGS. 4 to 7, heating and cooling are done in the load-lock chamber. Even in the step including BARC and TARC, heating/cooling in after resist coating may be done in the load-lock chamber.

[Fourth Embodiment]

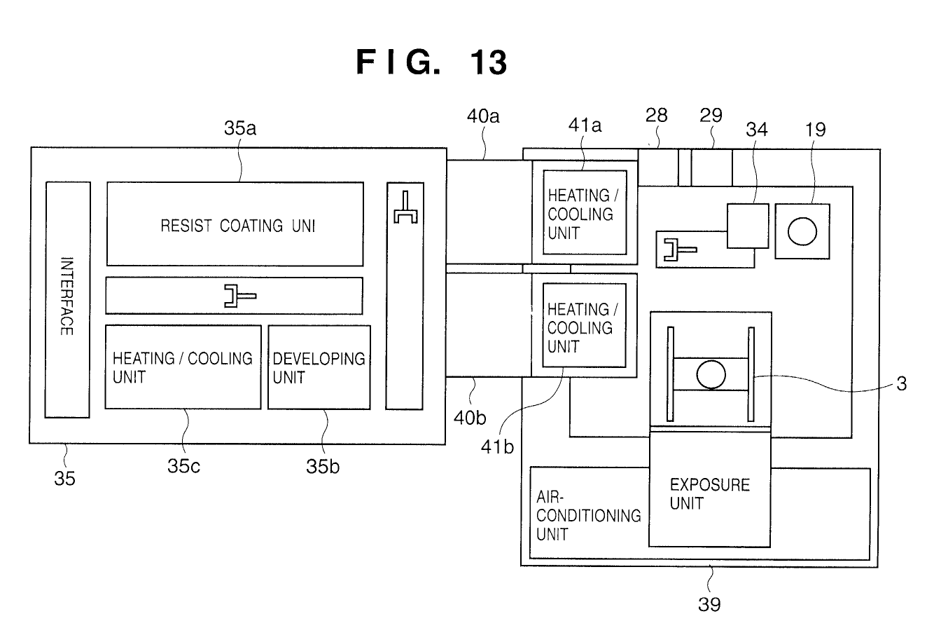

FIG. 13 is a schematic view showing an example of a semiconductor manufacturing system according to the fourth embodiment of the present invention.

The semiconductor manufacturing system of the fourth embodiment is the same as that of the third embodiment except that in-line port sections 40a and 40b for transporting a wafer to an exposure apparatus 39 have only a load-lock function and heating/cooling units 41a and 41b serving as wafer temperature controller are arranged in the exposure apparatus 39 near the port sections 40a and 40b. The heating/cooling units 41a and 41b are in the purge environment of the exposure apparatus 39, but return gas from these units passes through another circulation system. Alternatively, the heating/cooling units 41a and 41b may use a temperature adjustment/purge system different from that of the exposure apparatus 39 or may exhaust return gas. For this purpose, the semiconductor manufacturing system comprises an air-conditioner (not shown) for adjusting the atmosphere around the temperature controllers, other than an air-conditioner (not shown) for a purge environment.

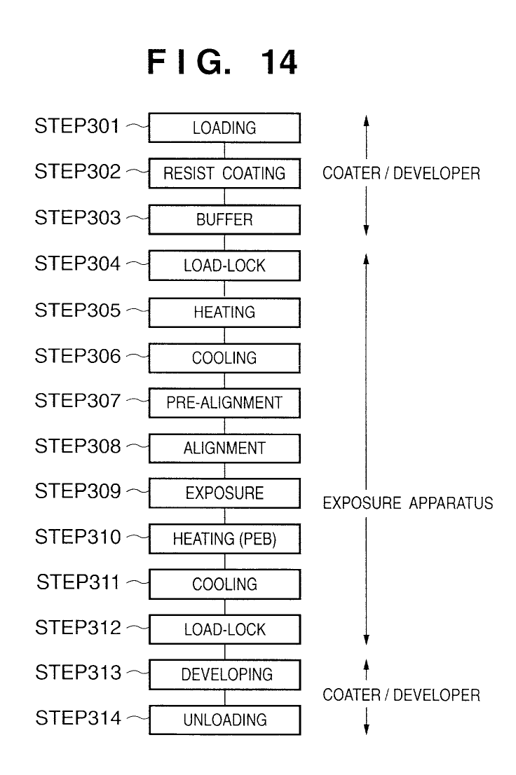

A processing flow in the semiconductor manufacturing system of the fourth embodiment shown in FIG. 13 in the wafer process of the semiconductor manufacture will be explained with reference to the flow chart of FIG. 14. The operation of each apparatus in the fourth embodiment is controlled by a controller (not shown), and the controller controls the operation timing in the following flow chart.

In the fourth embodiment, processing from wafer loading into a CDS 35 (step 301) up to wafer unloading to the in-line port section 40a (step 303) is the same as in the third embodiment.

In the in-line port section 40a, the door on the exposure apparatus 39 side is kept closed, and after a wafer is loaded from the door on the CDS 35 side, the two doors are closed to seal the in-line port section 40a. The internal atmosphere of the in-line port section 40a is temporarily evacuated, and N₂ gas is supplied to the in-line port section 40a (step 304). After this processing, the door on the exposure apparatus 39 side is opened, and the wafer is transported to the heating/cooling unit 41a by the transfer hand of the exposure apparatus 39. The wafer set on the heating/cooling unit 41a is pre-baked (step 305), cooled (step 306), and moved to a wafer temperature adjustment unit 34 by the transfer hand of the exposure apparatus 39. The wafer is pre-aligned (step 307), aligned (step 308), and exposed (step 309), as in the third embodiment.

The exposed wafer is returned to the heating/cooling unit 41a again, subjected to PEB (step 310), and cooled (step 311). Then, the wafer is loaded into the in-line port section 40a again. The in-line port section 40a is in the N₂ atmosphere in advance, and the door of the in-line port section 40a on the CDS 35 side is kept closed. After the wafer is loaded into the in-line port section 40a, the two doors are closed to seal the in-line port section 40a. Then, only the door on the CDS 35 side is opened, and the wafer is transported to the CDS 35 via a buffer (step 312). The wafer is transferred to a developing unit 35b of the CDS 35 where the wafer is developed (step 313). After that, the wafer is unloaded from the CDS 35 via a heating/cooling unit 35c (step 314), and transported to other processing apparatuses.

Although not described in the fourth embodiment, the in-line port section 40b and heating/cooling unit 41b are used to successively process a plurality of wafers, similar to the third embodiment.

As described above, the fourth embodiment can prevent degradation of the internal atmosphere of the exposure apparatus without decreasing the throughput in loading/unloading a wafer into/from the exposure apparatus.

The fourth embodiment can reduce degradation of the image quality caused by resist degradation because the wafer atmosphere is controlled earlier than the prior art after a wafer is coated with a resist.

In addition, the fourth embodiment can reduce degradation of the image quality caused by resist degradation because an exposed wafer undergoes PEB at an atmosphere-controlled place.

[Fifth Embodiment]

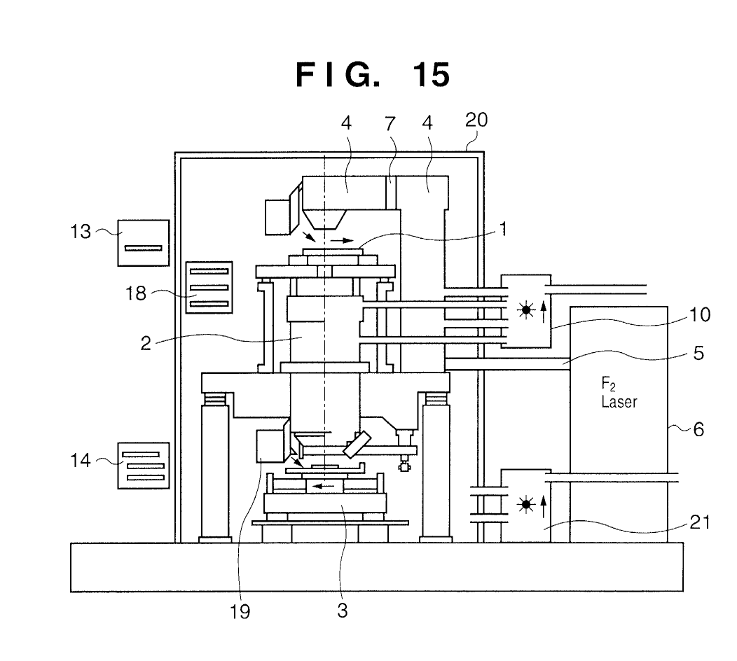

FIG. 15 is a schematic sectional view showing another example of a semiconductor exposure apparatus using an F₂ excimer laser as a light source according to the present invention.

In the apparatus of the fifth embodiment, the overall exposure apparatus is covered with a housing 20, and O₂ and H₂O in the housing 20 are purged by N₂ gas. Reference numeral 21 denotes an air-conditioner for adjusting the interior of the housing 20 to the N₂ atmosphere. In the fifth embodiment, the internal spaces of a lens barrel 2 and illumination optical system 4 are partitioned from the internal space (driving system space) of the housing 20, and independently adjusted to the He atmosphere.

A method of controlling a wafer load-lock chamber 14, i.e., a wafer loading/unloading method in the fifth embodiment is the same as those in the first to fourth embodiments. When the whole apparatus need not be strictly purged (e.g., when purge gas is supplied near the exposure light path), a simple, low-cost apparatus arrangement can be realized.

The above-described arrangement can prevent a decrease in cleanliness and degradation of the internal environment caused by an increase in concentration such as the O₂ or H₂O amount in the exposure apparatus in loading/unloading a wafer, reticle, or the like. As a result, the running cost of the air-conditioner and the cost of purge gas in the exposure apparatus can be suppressed.

[Embodiment of Network-Compatible System]

A production system for a semiconductor device (semiconductor chip such as an IC or LSI, liquid crystal panel, CCD, thin-film magnetic head, micromachine, or the like) will be exemplified. A trouble remedy or periodic maintenance of a manufacturing apparatus installed in a semiconductor manufacturing factory, or maintenance service such as software distribution is performed by using a computer network outside the manufacturing factory.

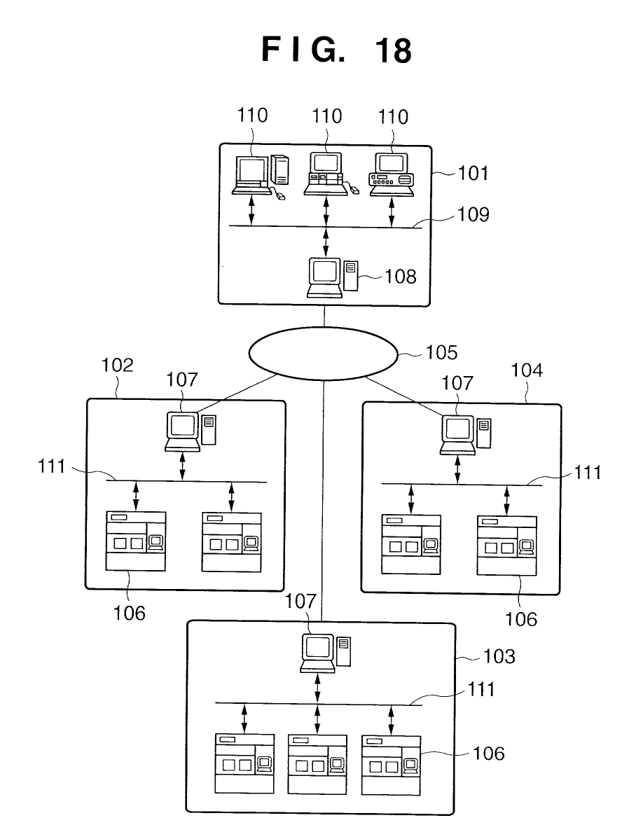

FIG. 18 shows the overall system cut out at a given angle. In FIG. 18, reference numeral 101 denotes a business office of a vendor (apparatus supply manufacturer) which provides a semiconductor device manufacturing apparatus. Assumed examples of the manufacturing apparatus are semiconductor manufacturing apparatuses for various processes used in a semiconductor manufacturing factory, such as pre-process apparatuses (lithography apparatus including an exposure apparatus, resist processing apparatus, and etching apparatus, annealing apparatus, film formation apparatus, planarization apparatus, and the like) and post-process apparatuses (assembly apparatus, inspection apparatus, and the like). The business office 101 comprises a host management system 108 for providing a maintenance database for the manufacturing apparatus, a plurality of operation terminal computers 110, and a LAN (Local Area Network) 109 which connects the host management system 108 and computers 110 to build an intranet. The host management system 108 has a gateway for connecting the LAN 109 to Internet 105 as an external network of the business office, and a security function for limiting external accesses.

Reference numerals 102 to 104 denote manufacturing factories of the semiconductor manufacturer as users of manufacturing apparatuses. The manufacturing factories 102 to 104 may belong to different manufacturers or the same manufacturer (pre-process factory, post-process factory, and the like). Each of the factories 102 to 104 is equipped with a plurality of manufacturing apparatuses 106, a LAN (Local Area Network) 111 which connects these apparatuses 106 to construct an intranet, and a host management system 107 serving as a monitoring apparatus for monitoring the operation status of each manufacturing apparatus 106. The host management system 107 in each of the factories 102 to 104 has a gateway for connecting the LAN 111 in the factory to the Internet 105 as an external network of the factory. Each factory can access the host management system 108 of the vendor 101 from the LAN 111 via the Internet 105. The security function of the host management system 108 authorizes access of only a limited user. More specifically, the factory notifies the vendor via the Internet 105 of status information (e.g., the symptom of a manufacturing apparatus in trouble) representing the operation status of each manufacturing apparatus 106, and receives response information (e.g., information designating a remedy against the trouble, or remedy software or data) corresponding to the notification, or maintenance information such as the latest software or help information. Data communication between the factories 102 to 104 and the vendor 101 and data communication via the LAN 111 in each factory adopt a communication protocol (TCP/IP) generally used in the Internet. Instead of using the Internet as an external network of the factory, a dedicated network (e.g., ISDN) having high security which inhibits access of a third party can be adopted. Also the user may construct a database in addition to the one provided by the vendor and set the database on an external network, and the host management system may authorize access to the database from a plurality of user factories.

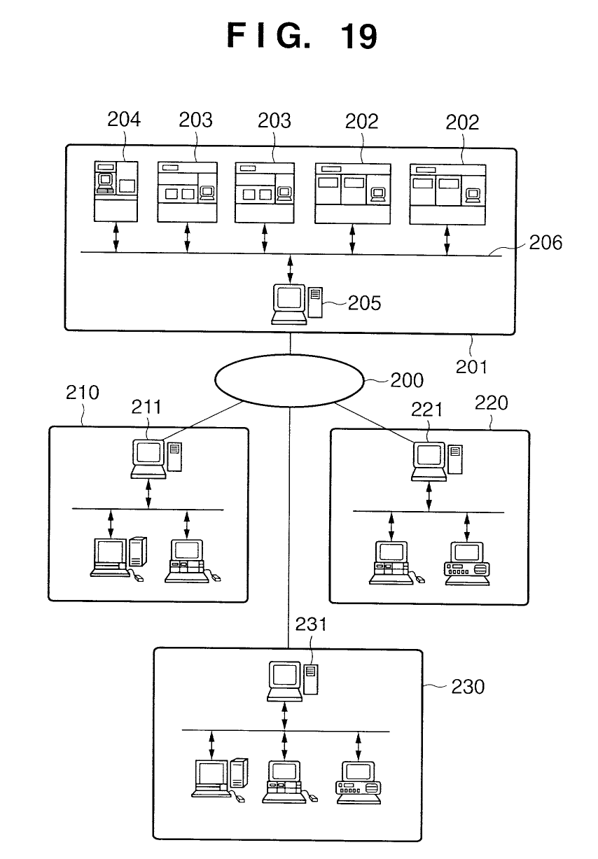

FIG. 19 is a view showing the concept of the overall system of this embodiment that is cut out at a different angle from FIG. 18. In the above example, a plurality of user factories having manufacturing apparatuses and the management system of the manufacturing apparatus vendor are connected via an external network, and production management of each factory or information of at least one manufacturing apparatus is communicated via the external network. In the example of FIG. 19, a factory having manufacturing apparatuses of a plurality of vendors and the management systems of the vendors for these manufacturing apparatuses are connected via the external network of the factory, and maintenance information of each manufacturing apparatus is communicated. In FIG. 19, reference numeral 201 denotes a manufacturing factory of a manufacturing apparatus user (semiconductor device manufacturer) where manufacturing apparatuses for various processes, e.g., an exposure apparatus 202, resist processing apparatus 203, and film formation apparatus 204 are installed in the manufacturing line of the factory. FIG. 19 shows only one manufacturing factory 201, but a plurality of factories are networked in practice. The respective apparatuses in the factory are connected to a LAN 2060 to build an intranet, and a host management system 205 manages the operation of the manufacturing line. The business offices of vendors (apparatus supply manufacturers) such as an exposure apparatus manufacturer 210, resist processing apparatus manufacturer 220, and film formation apparatus manufacturer 230 comprise host management systems 211, 221, and 231 for executing remote maintenance for the supplied apparatuses. Each host management system has a maintenance database and a gateway for an external network, as described above. The host management system 205 for managing the apparatuses in the manufacturing factory of the user, and the management systems 211, 221, and 231 of the vendors for the respective apparatuses are connected via the Internet or dedicated network serving as an external network 200. If a trouble occurs in any one of a series of manufacturing apparatuses along the manufacturing line in this system, the operation of the manufacturing line stops. This trouble can be quickly solved by remote maintenance from the vendor of the apparatus in trouble via the Internet 200. This can minimize the stop of the manufacturing line.

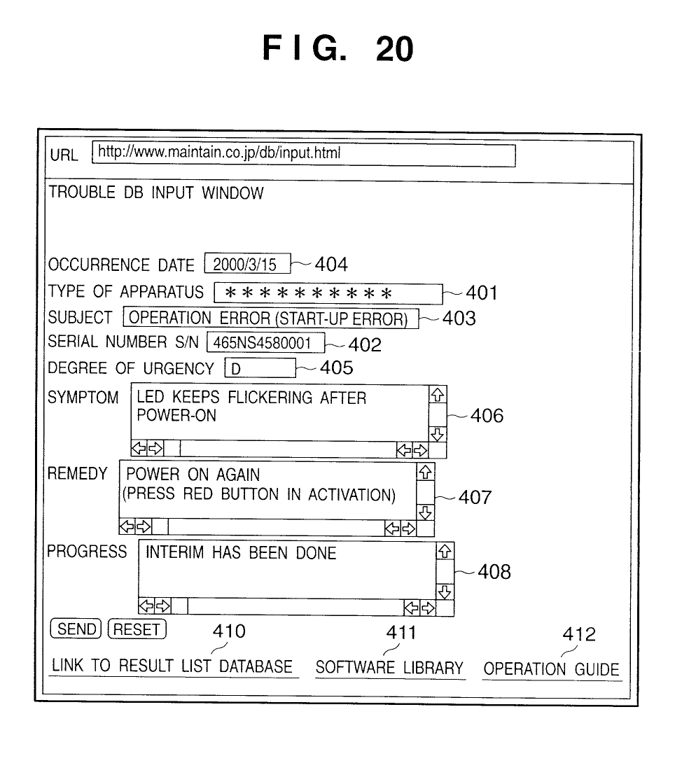

Each manufacturing apparatus in the semiconductor manufacturing factory comprises a display, a network interface, and a computer for executing network access software and apparatus operating software which are stored in a storage device. The storage device is a built-in memory, hard disk, or network file server. The network access software includes a dedicated or general-purpose web browser, and provides a user interface having a window as shown in FIG. 20 on the display. While referring to this window, the operator who manages manufacturing apparatuses in each factory inputs, in input items on the windows, pieces of information such as the type of manufacturing apparatus (401), serial number (402), subject of trouble (403), occurrence date (404), degree of urgency (405), symptom (406), remedy (407), and progress (408). The pieces of input information are transmitted to the maintenance database via the Internet, and appropriate maintenance information is sent back from the maintenance database and displayed on the display. The user interface provided by the web browser realizes hyperlink functions (410 to 412), as shown in FIG. 20. This allows the operator to access detailed information of each item, receive the latest-version software to be used for a manufacturing apparatus from a software library provided by a vendor, and receive an operation guide (help information) as a reference for the operator in the factory.

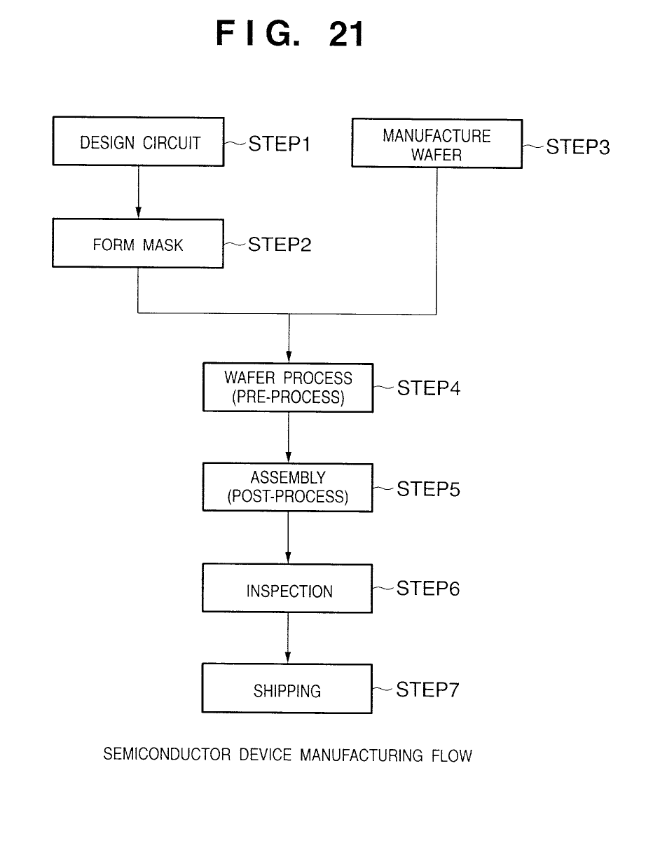

A semiconductor device manufacturing process using the above-described production system will be explained. FIG. 21 shows the flow of the whole manufacturing process of the semiconductor device. In step 1 (circuit design), a semiconductor device circuit is designed. In step 2 (mask formation), a mask having the designed circuit pattern is formed. In step 3 (wafer manufacture), a wafer is manufactured by using a material such as silicon. In step 4 (wafer process) called a pre-process, an actual circuit is formed on the wafer by lithography using a prepared mask and the wafer. Step 5 (assembly) called a post-process is the step of forming a semiconductor chip by using the wafer manufactured in step 4, and includes an assembly process (dicing and bonding) and packaging process (chip encapsulation). In step 6 (inspection), inspections such as the operation confirmation test and durability test of the semiconductor device manufactured in step 5 are conducted. After these steps, the semiconductor device is completed and shipped (step 7). For example, the pre-process and post-process are performed in separate dedicated factories, and maintenance is done for each of the factories by the above-described remote maintenance system. Information for production management and apparatus maintenance is communicated between the pre-process factory and the post-process factory via the Internet or dedicated network.

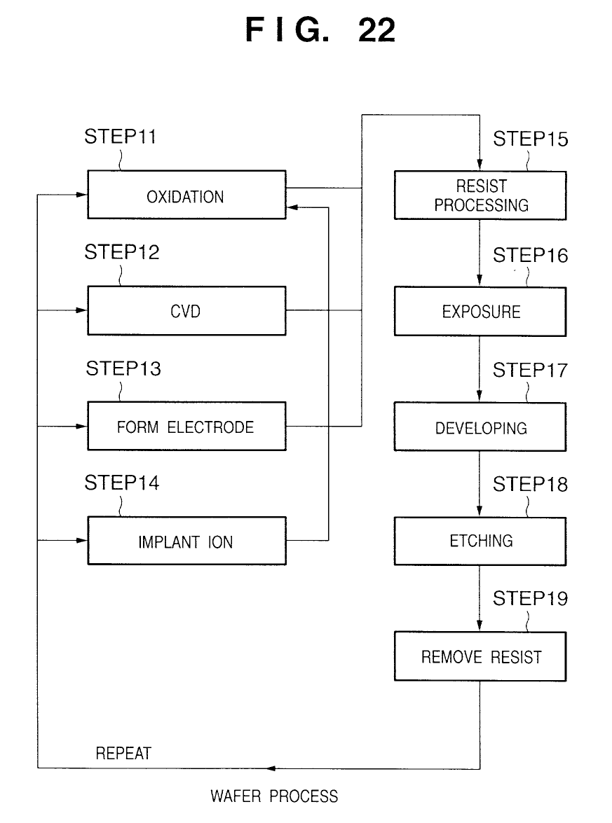

FIG. 22 shows the detailed flow of the wafer process. In step 11 (oxidation), the wafer surface is oxidized. In step 12 (CVD), an insulating film is formed on the wafer surface. In step 13 (electrode formation), an electrode is formed on the wafer by vapor deposition. In step 14 (ion implantation), ions are implanted in the wafer. In step 15 (resist processing), a photosensitive agent is applied to the wafer. In step 16 (exposure), the above-mentioned exposure apparatus exposes the wafer to the circuit pattern of a mask. In step 17 (developing), the exposed wafer is developed. In step 18 (etching), the resist is etched except for the developed resist image. In step 19 (resist removal), an unnecessary resist after etching is removed. These steps are repeated to form multiple circuit patterns on the wafer. A manufacturing apparatus used in each step undergoes maintenance by the remote maintenance system, which prevents a trouble in advance. Even if a trouble occurs, the manufacturing apparatus can be quickly recovered. The productivity of the semiconductor device can be increased in comparison with the prior art.

As many apparently widely different embodiments of the present invention can be made without departing from the spirit and scope thereof, it is to be understood that the invention is not limited to the specific embodiments thereof except as defined in the appended claims.

What is claimed is:

1. An exposure apparatus for exposing a wafer to a pattern, comprising:
a chamber that surrounds a predetermined space in the exposure apparatus;
an air-conditioner for adjusting an internal atmosphere of the exposure apparatus; and
a port section having a load-lock mechanism.

2. The apparatus according to claim 1, wherein said port section comprises an exhaust mechanism for exhausting gas from said port section, and a supply mechanism for supplying gas into said port section.

3. The apparatus according to claim 1, wherein said port section comprises a door for shielding said port section from outside of the exposure apparatus, and a door for shielding said port section from said chamber.

4. The apparatus according to claim 1, wherein said port section includes a plurality of port sections.

5. The apparatus according to claim 4, wherein said port section includes a first port section for loading the wafer and a second port section for unloading the wafer.

6. The apparatus according to claim 1, further comprising an interface for stocking a wafer between said port section and outside of the exposure apparatus.

7. The apparatus according to claim 6, wherein said interface comprises a load-lock mechanism.

8. The apparatus according to claim 6, wherein said interface is shared between a first port section for loading a wafer and a second port section for unloading the wafer.

9. The apparatus according to claim 6, wherein said interface is interposed between said port section and a coating/developing system.

10. The apparatus according to claim 1, wherein said port section comprises a temperature control mechanism for controlling a temperature of the wafer.

11. The apparatus according to claim 10, wherein the temperature control mechanism comprises a heater for heating the wafer.

12. The apparatus according to claim 11, wherein the heater heats the wafer.

13. The apparatus according to claim 12, wherein the wafer to be heated is a wafer coated with a resist.

14. The apparatus according to claim 11, wherein the heater heats an exposed wafer.

15. The apparatus according to claim 10, wherein the temperature control mechanism comprises a cooler for cooling the wafer.

16. The apparatus according to claim 15, wherein the cooler cools a heated wafer.

17. The apparatus according to claim 10, wherein the temperature control mechanism controls the temperature of the wafer while an internal atmosphere of said port section is set close to an internal atmosphere of the exposure apparatus.

18. The apparatus according to claim 10, wherein the temperature control mechanism controls the temperature of the wafer while gas in said port section is exhausted.

19. The apparatus according to claim 18, wherein the wafer is heated while gas in said port section is exhausted.

20. The apparatus according to claim 18, wherein the wafer is cooled while gas is supplied to said port section.

21. The apparatus according to claim 1, further comprising a temperature controller incorporated in said chamber to control a temperature of the wafer.

22. The apparatus according to claim 1, further comprising another air-conditioner which is different from said air-conditioner and adjusts an ambient atmosphere of a temperature controller.

23. A wafer transfer method of transferring a wafer into an exposure apparatus, comprising the steps of:
transferring a wafer coated with a resist or anti-reflective agent to a port section having a load-lock mechanism;
heating the wafer transferred to the port section;
exhausting gas from the port section;
cooling the heated wafer;
supplying gas to the port section; and
transferring the wafer in the port section to the exposure apparatus.

24. The method according to claim 23, further comprising the step of controlling a temperature of the wafer transferred to the exposure apparatus by an internal temperature controller of the exposure apparatus.

25. A wafer processing method comprising the steps of:
coating a wafer with a resist or anti-reflective agent;
heating the wafer; and
exhausting an ambient atmosphere of the wafer before heating of the wafer ends.

26. The method according to claim 25, further comprising the step of supplying gas around the wafer after an ambient atmosphere of the wafer is exhausted.

27. The method according to claim 25, further comprising the step of cooling the heated wafer before the step of supplying gas around the wafer ends.

28. A coating/developing system having a resist coating unit for coating a wafer with a resist and a developing unit for developing the exposed wafer, comprising:
a door for shielding the coating/developing system from a heating unit disposed outside the coating/developing system in order to pre-bake the wafer.

29. The system according to claim 28, further comprising a hand for unloading the wafer to the heating unit.

30. The system according to claim 29, further comprising a controller for controlling the hand.

31. The system according to claim 30, wherein said controller selects a plurality of external heating units and controls transfer of the wafer.

32. The system according to claim 30, further comprising another hand which is different from said hand and loads the wafer from a device outside the coating/developing system.

33. The system according to claim 32, wherein said hand for loading the wafer includes a hand for loading a heated wafer from an external device for heating an exposed wafer.

34. The system according to claim 28, further comprising a coating unit for an anti-reflective agent.

35. The system according to claim 34, wherein said coating unit applies the anti-reflective agent at least before or after resist coating.

36. A device manufacturing system comprising:
a coating/developing system having a resist coating unit for coating a wafer with a resist and a developing unit for developing the exposed wafer;
an exposure apparatus for exposing the wafer to a pattern of a master;
a port section which is interposed between said coating/developing system and said exposure apparatus and has a load-lock mechanism; and
a temperature control mechanism incorporated in said port section to control a temperature of the wafer.

37. The system according to claim 36, wherein said port section comprises an exhaust mechanism for exhausting gas from said port section, and a supply mechanism for supplying gas into said port section.

38. The system according to claim 36, wherein said temperature control mechanism heats the wafer.

39. The system according to claim 38, wherein the wafer to be heated is a wafer coated with a resist.

40. The system according to claim 36, further comprising a controller for controlling to heat while an internal atmosphere of said port section is set close to an internal atmosphere of said exposure apparatus after the wafer is transferred to said port section.

41. A device manufacturing method comprising the steps of:
installing manufacturing apparatuses for various processes of a device manufacturing system in a semiconductor manufacturing factory; and
manufacturing a semiconductor device by using the manufacturing apparatuses in a plurality of processes,
the device manufacturing system having
a coating/developing system having a resist coating unit for coating a wafer with a resist and a developing unit for developing the exposed wafer,
an exposure apparatus for exposing the wafer to a pattern of a master,
a port section which is interposed between the coating/developing system and the exposure apparatus and has a load-lock mechanism, and
a temperature control mechanism incorporated in the port section to control a temperature of the wafer.

42. The method according to claim 41, further comprising the steps of:
connecting the manufacturing apparatuses by a local area network; and
communicating information about at least one of the manufacturing apparatuses between the local area network and an external network outside the semiconductor manufacturing factory.

43. The method according to claim 41, wherein a database provided by a vendor or user of the exposure apparatus is accessed via the external network to obtain maintenance information of the manufacturing apparatus by data communication, or production management is performed by data communication between the semiconductor manufacturing factory and another semiconductor manufacturing factory via the external network.

44. A semiconductor manufacturing factory comprising:
manufacturing apparatuses for various processes in a device manufacturing system;
a local area network for connecting said manufacturing apparatuses; and
a gateway which allows the local area network to access an external network outside the factory,
wherein information about at least one of said manufacturing apparatuses can be communicated, and
the device manufacturing system has
a coating/developing system having a resist coating unit for coating a wafer with a resist and a developing unit for developing the exposed wafer,
an exposure apparatus for exposing the wafer to a pattern of a master,
a port section which is interposed between the coating/developing system and the exposure apparatus and has a load-lock mechanism, and
a temperature control mechanism incorporated in the port section to control a temperature of the wafer.

45. A maintenance method for an exposure apparatus installed in a semiconductor manufacturing factory, comprising the steps of:
causing a vendor or user of the exposure apparatus to provide a maintenance database connected to an external network of the semiconductor manufacturing factory;
authorizing access from the semiconductor manufacturing factory to the maintenance database via the external network; and
transmitting maintenance information accumulated in the maintenance database to the semiconductor manufacturing factory via the external network,
the exposure apparatus having
a chamber that surrounds a predetermined space in the exposure apparatus,
an air-conditioner for adjusting an internal atmosphere of the exposure apparatus, and
a port section having a load-lock mechanism.

46. An exposure apparatus for exposing a wafer to a pattern, comprising:
a chamber that surrounds a predetermined space in the exposure apparatus;
an air-conditioner for adjusting an internal atmosphere of the exposure apparatus;
a port section having a load-lock mechanism;
a display;
a network interface; and
a computer for executing network software,
wherein maintenance information of the exposure apparatus can be communicated via the computer network.

47. The apparatus according to claim 46, wherein the network software is connected to an external network of a factory where the exposure apparatus is installed, provides on said display a user interface for accessing a maintenance database provided by a vendor or user of the exposure apparatus, and enables obtaining information from the database via the external network.
